(19) United States
(12) Patent Application Publication
(10) Pub. No.: US 2008/0307709 A1
(43) Pub. Date: Dec. 18, 2008

(54) DUAL SWING POWERED GATE ACTUATOR

(76) Inventor: Edward J. Stull, Oxford, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/138,504

(22) Filed: Jun. 13, 2008

Related U.S. Application Data
(60) Provisional application No. 60/944,197, filed on Jun. 15, 2007.
(60) Provisional application No. 60/991,345, filed on Nov. 30, 2007.

(51) Int. Cl. E05F 15/00

(52) U.S. Cl. 49/280; 49/358

(57) ABSTRACT

A powered gate post assembly includes an inner post that supports a rotating outer post. The inner post includes a drive slot that translates vertical motion of a drive pin into rotating motion. The drive pin is drivingly engaged to the outer post to drive rotation of the outer post. The drive slot in the inner post includes first and second portions that provide for swinging the gate in two directions from a closed position.

### CROSS REFERENCE TO RELATED APPLICATION

The application claims priority to U.S. Provisional Application No. 60/944,197 filed Jun. 15, 2007, and 60/991,345 filed Nov. 30, 2007.

### BACKGROUND OF THE INVENTION

This invention generally relates to powered gate actuators. More particularly, this invention relates to a gate actuator for swinging a gate open in two directions.

Large gates utilized for security and to provide privacy are often opened by way of a powered actuator. The powered actuator provides for opening and closing of a gate without having to leave the safety and comfort of a vehicle. Conventional powered actuators are typically required to be quite large and powerful in order to move large heavy gates. Further, such actuators are limited to opening the gate in one direction. Accordingly, a vehicle must stop well before a gate to provide room for opening of the gate to open. In some instances this may require a vehicle to back up in order to provide clearance for the gate. In other instances, the room required for the gate to open and for the vehicle to be spaced apart from the gate is not available, and therefore requires the gate and actuator to be installed to swing the gate open in a less than desirable direction.

### SUMMARY OF THE INVENTION

A disclosed powered gate post assembly includes an inner post that supports a rotating outer post. The inner post includes a drive slot that translates vertical motion of a drive pin into rotating motion. The drive pin is drivingly engaged to the outer post to drive rotation of the outer post.

The drive slot in the inner post includes first and second portions that provide for swinging open of the gate in two directions. The actuator drives the drive pin in a first direction to open a gate in a first direction and in a second direction to open the gate in the opposite direction. The outer post is supported on the inner post by a ball bearing disposed along the axis of rotation.

Accordingly, the example disclosed gate assembly provides two way powered gate operation. These and other features of the present invention can be best understood from the following specification and drawings, the following of which is a brief description.

### BRIEF DESCRIPTION OF THE DRAWINGS

FIG. 1 is a cross-section of an example powered gate post.

FIG. 2 is a schematic view of another example powered gate post.

FIG. 3 is a cross-sectional view of an example powered gate post

FIG. 4 is a plan view of an example drive pin.

FIG. 5 is a cross-sectional view of an example D-shaped powered gate post.

FIG. 6 is an enlarged view of an example channel of the D-shaped powered gate post.

FIG. 7 is a schematic view of an example drive slot of an inner tube.

FIG. 8 is a schematic view of an example gate assembly.

FIG. 9 is a sequence of views illustrating a relative position between an example powered gate post and a fixed post.

FIG. 10 is a schematic view of an example gate assembly rotatable about a central axis.

FIG. 11 is a cross-sectional view of an example clutch assembly.

FIG. 12 is an example view of an example adjustment mechanism for the example clutch assembly.

FIG. 13 is a cross-sectional view of another example clutch assembly.

FIG. 14 is a top view of the example clutch assembly of FIG. 13.

### DETAILED DESCRIPTION OF THE PREFERRED EMBODIMENT

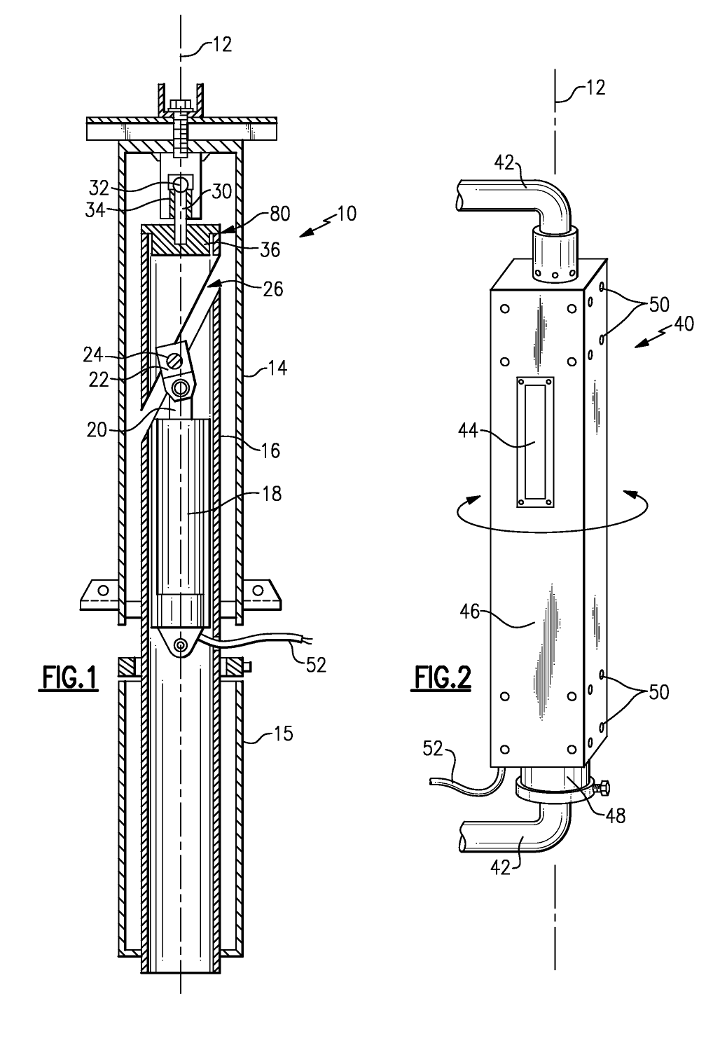

Referring to FIG. 1, an example powered gate post assembly 10 provides for the automatic or remote operation of a gate and includes an inner post 16 that is received within a ground sleeve 15 and supports an outer post 14. The powered post assembly 10 includes an actuator 18 that drives a drive pin 24 disposed within a drive slot 26. The example actuator 18 is disposed entirely within the inner post 16 and therefore is hidden from view. A trunion 22 links a shaft 20 of the actuator 18 to the drive pin 24. The actuator 18 is mounted to the inner post 16 and the drive pin 24 is movable within the drive slot 26 and attached to the outer post 14 (FIG. 3).

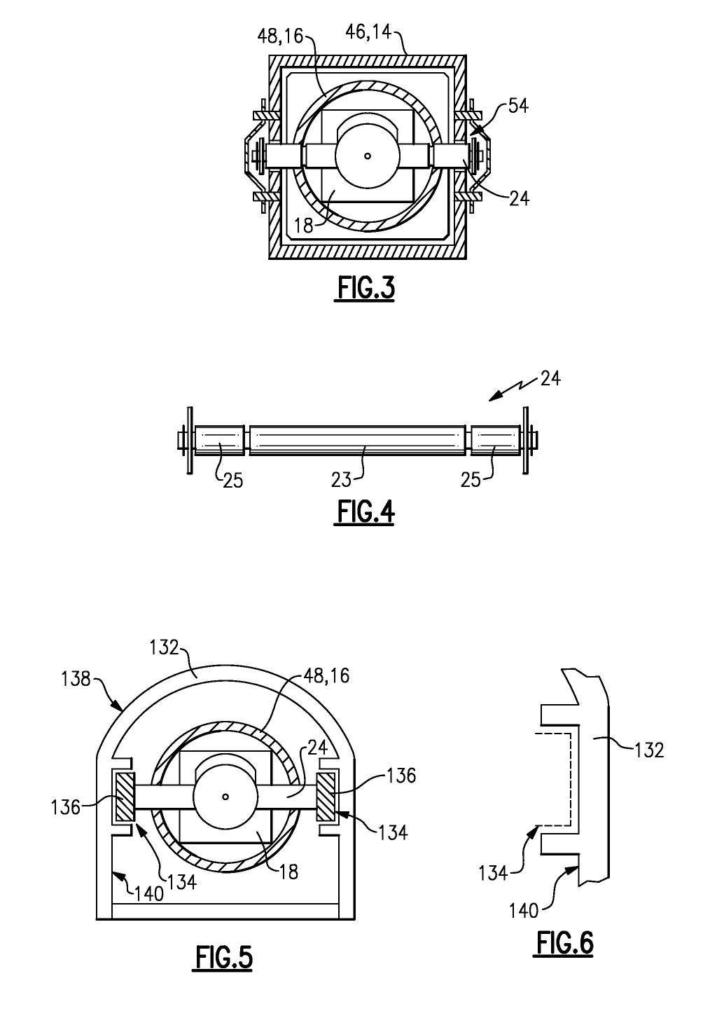

Referring to FIG. 2, another example powered post assembly 40 includes mounting brackets 42 for mounting to a fixed structure. The actuator 18 is mounted within an inner post 48, to rotate an outer post 46. An access panel 44 is provided to gain access to internal components. Mounting screws 50 facilitate mounting of a gate to the rotating outer post 46. A power cord 52 communicates electrical power to the actuator 18. FIGS. 1 and 2 illustrate different example embodiments utilizing the similar structure of an outer tube rotatable about an inner tube. The different examples illustrate different mounting methods, and as such also demonstrate that other configurations for mounting to accommodate different gate structures are within the contemplation of this invention.

Referring to FIG. 3 with continuing reference to FIGS. 1, the example actuator 18 is a linear actuator that includes a ball screw shaft 20. Movement of the actuator 18 linearly moves the drive pin 24 within the drive slot 26 to cause a corresponding rotation of the drive pin 24 and thereby the outer post 14. The drive pin 24 moves within the drive slot 26 and are disposed within a vertical slot 54 of the outer housing 46. The drive slot 26 includes a shape that rotates the drive pin 86 about the axis 15 responsive to vertical movement. The vertical slot 54 within the outer housing 46 does not include any twisting shape, but is instead a straight vertical slot to accommodate vertical movement.

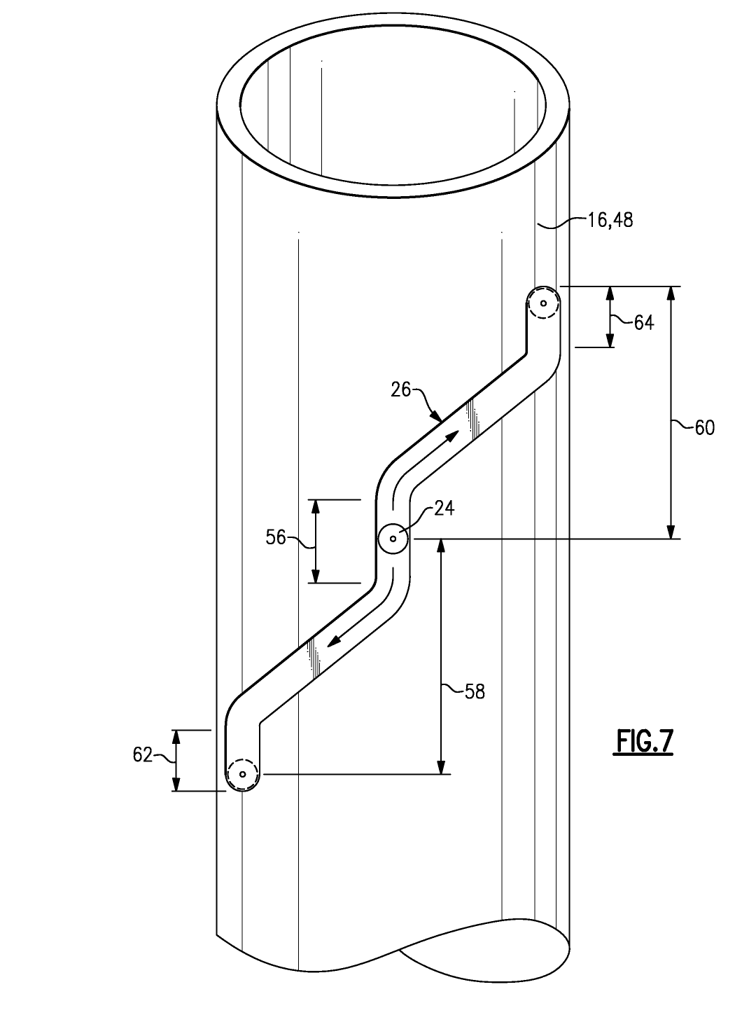

Referring to FIG. 4, the example drive pin 24 includes a center section 23 and two distal bearing sections 25. The bearing sections 25 engage the slot 54 within the outer housing 46, 14. The center section 23 is connected to the actuator 18.

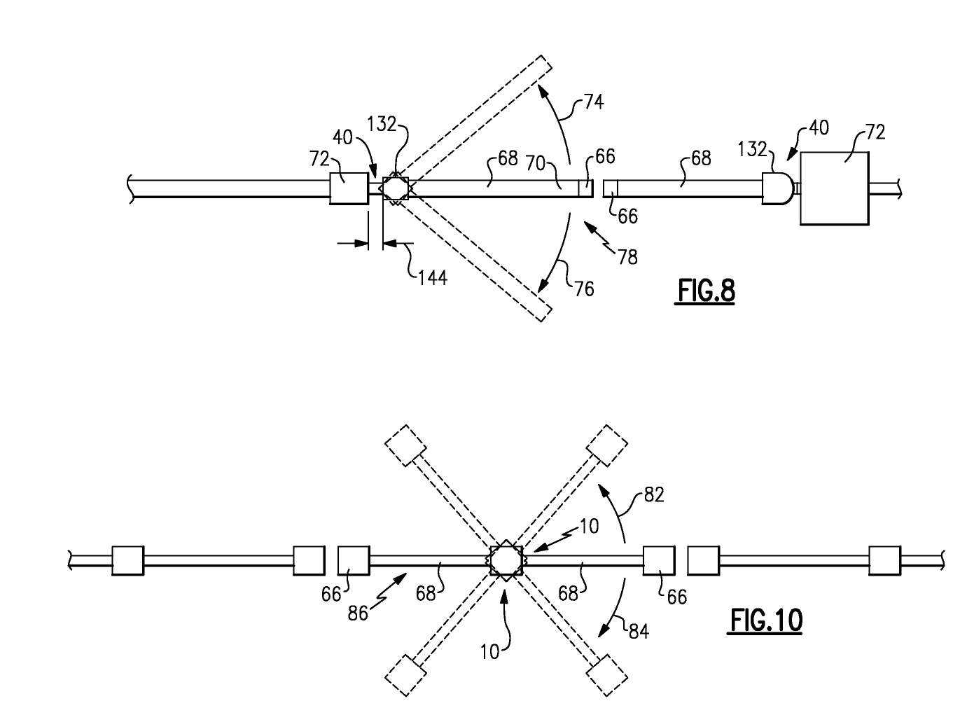

Referring to FIGS. 5 and 6, another example outer housing 132 including a D-shaped cross-section. The D-shaped cross-sectional configuration of the outer housing 132 provide for a constant distance during rotation between a fixed structure and the rotating power post assembly 10. The housing 132 includes an outer surface with a curved portion 138. The curved portion 128 is positioned adjacent the fixed structure and provides the desired constant spacing during rotation of the gate.

The housing 132 includes a guide channels 134 disposed on an internal surface 140. The guide channels 134 receive guide blocks 136 that are attached to the drive pin 24. The drive pin 24 moves vertically responsive to movement of the actuator 18. The vertical movement is translated into rotational movement by a drive slot 26 of the inner tube 16. The guide blocks 136 slide vertically within the guide channels 134 to translate the rotational movement of the drive pin 24 into rotation of the outer housing 132.

Referring to FIG. 7, the drive slot 26 within the inner post 16, 48 provides dual swinging operation of the power post assemblies 10, 40. The drive slot 26 includes a central normal or closed gate position. The normal position includes a length 56 to provide for alignment and tolerances in the gate mechanism. Accordingly, travel of the drive pin 24 within the length 56 does not result in turning of the outer post, or opening of the gate assembly.

Continued movement of the drive pin 24 within the slot moves into one of the first section 60 or the second section 58. Movement into the first section 60 drives the gate assembly in a first direction and movement into the second direction moves the gate assembly in the second direction. The length of the first section 60 and the second section 58 provides the desired radial opening length of a gate. The actuator 18 either extends the shaft 20 upward to move the drive pin in the first direction or draws the shaft downwardly to move the drive pin 24 toward the second section 58. The corresponding movement results in a desired rotation of the gate assembly.

Referring to FIG. 8, a gate 70 supported on the post assembly 40 is therefore provided with dual opening direction capability. The example gate 70 includes a second post 66 spaced apart from the drive post 40 by rails 68. As appreciated, other horizontal structures for supporting the second post 66 spaced apart from the drive post are within the contemplation of this invention.

Moving the actuator upwardly provides for opening of the gate in the first direction 74 and downward movement provides for opening of the gate in the second direction 76. Of course opposite movements could be utilized to provide the same desired result. The directions are by way of explanation and not limitation. The example gate 70 includes the D-shaped outer housing 132 to maintain a desired spacing 144 between the fixed structure 72 and the rotating outer housing 132.

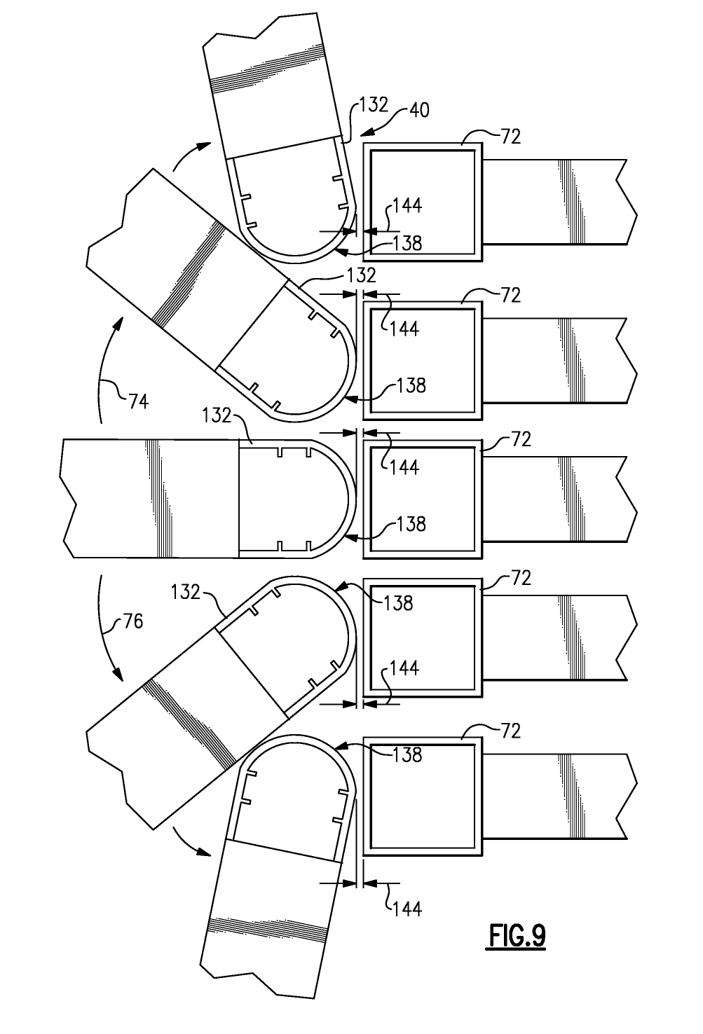

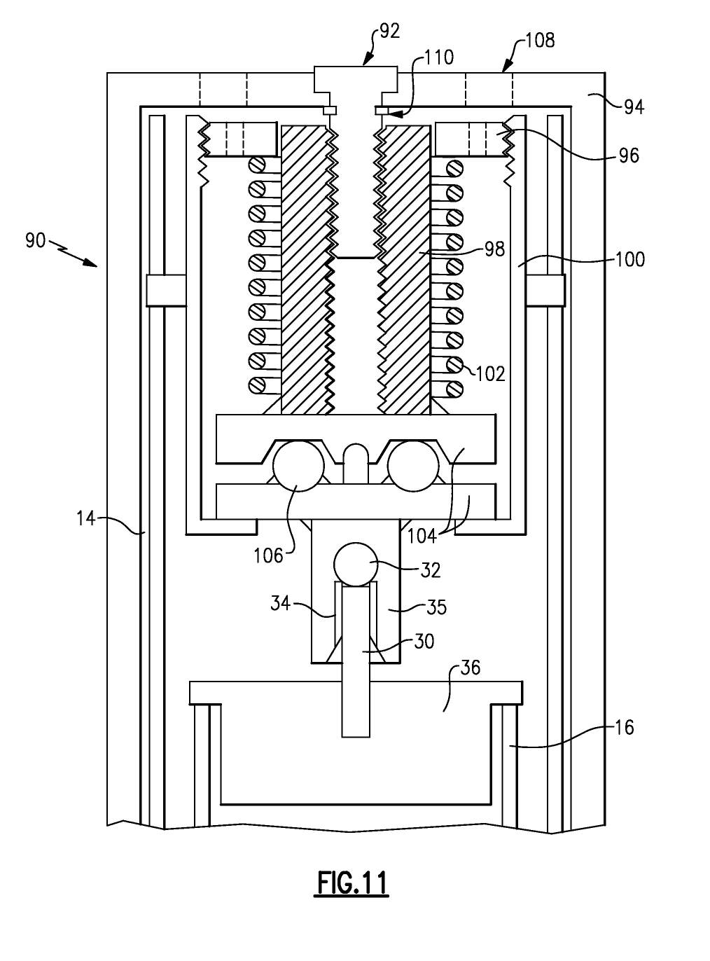

Referring to FIG. 9, the interaction between the outer housing 132 and the fixed structure 72 is illustrated through a sequence of opening the gate 70. Rotation of the drive post 40 causes rotation of the gate 70 either in a first direction 74, or in a second direction 76 as is desired. The curved portion 132 is disposed adjacent the fixed support 72 at a fixed spaced apart distance 144. Rotation from the closed position (illustrated at center) does not change the distance 144 because the curved shape accommodates the change in relative rotational position between the gate 70 and the fixed support 72. Accordingly, the curved surface 132 provides a fixed spacing between the moving drive post 40 and the fixed support 72 regardless of the rotational position of the gate 70.

Referring to FIG. 10, the example power post assembly 10 can be utilized to rotate a gate 86 about the central axis 12 either clockwise 84 or counterclockwise 82. Rotation about the central axis provides for application to rotating gates that are supported for rotation by a central powered post 10. As appreciated the example slot configuration provides this capability without change over or adjustment. Prior art gate opening devices provide for opening of a gate in one direction that can be changed upon adjustment or different preferential installation configurations. However, such devices are not provided that allow selective opening based upon a current situation.

For example an operator exiting through the gate 70 in a first direction can have the gate open in the first direction 74 or away from their current position. Upon a return through the gate from the outer side can operate the gate to open in the opposite direction. The preferential opening of the gate 70 can be manually performed by way of specific directional remote control. Further, the preferential opening direction of the gate can be triggered by a proximity sensor that determines a side on which a person or vehicle is positioned and utilizing that information open the gate to swing in the opposite direction. Further, such proximity sensors can provide the additional service of preventing unintentional opening of the gate such that it swings into an object within the gates swing path.

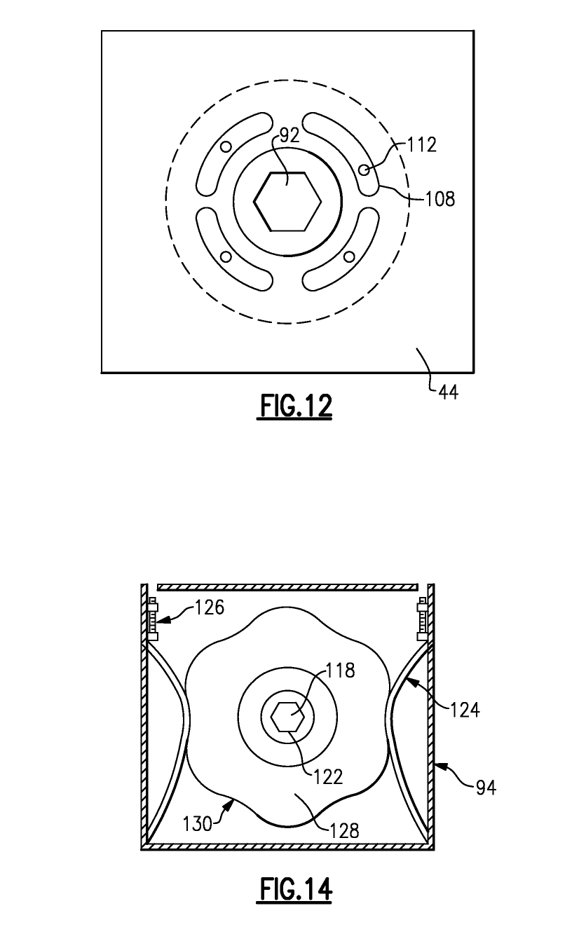

Referring to FIGS. 11 and 12, the example powered gate posts 10, 40 can include a clutch mechanism 90 that protects the actuator and corresponding linkages from potential damage caused by obstructions within the gate swing path. As appreciated, an obstruction such as a person or vehicle may enter or be in the gate swing path. Operation of the gate to open can cause undesired contact. However, the actuator may continue to move toward a desired open position, even though the gate is prevented from moving. Such an occurrence could potential damage the actuator and linkage components. The example clutch assembly provides for the selective decoupling an outer shell 94 relative to the outer tube 14 responsive to a physical obstruction that prevents movement of the gate.

The example clutch assembly 90 includes clutch plates 104 that are separated by bearings 106. The clutch plates 104 are biased toward each other by biasing member 102. The force exerted by the biasing member 102 is such that frictional forces between the bearings 106 cause a transfer of torque between the separated clutch plates 104. Rotational movement is transferred to a support member 98. The support member 98 includes inner threads that engage the threads on the mounting screw 92. The mounting screw 92 supports the outer shell 94 relative to the inner tube 16 and outer tube 14 and also provides adjustment of the height of the outer shell 94. A housing 100 includes inner threads that engage threads on an adjustment nut 96. The adjustment nut 96 moves one support for the biasing member 102 to adjust the force exerted by the biasing member 102.

The mounting nut 92 includes a snap ring 110 that maintains a desired clearance between the outer shell 94 and the outer tube 14. The example clutch assembly 90 is supported by a journal assembly including a ball 32 supported by a post 30. The post 30 is fixed to the cap 36 attached to the inner tube 16. A bearing surface 34 within a cup portion 35 aligns the post 30 with the ball 32. Further, the bearing surface 34 provides a low friction surface that reduces binding between the shaft 30 and the cup portion 35.

The adjustment nut 96 is accessed through openings 108 to facilitate rotation of the nut 96. The nut 96 includes openings 112 to receive a tool utilized to rotate the nut 96 without removal or disassembly. The outer shell 94 includes slot shaped openings that align with the openings 112 to facilitate rotation of the nut 96 as is desired to adjust the biasing force exerted on the clutch plates 104. As appreciated, the greater the force exerted on the clutch plates 104, the greater friction generated, and the more torque transferred to the outer shell 94. The torque or force that the gate will exert on an object within the swing path of the gate can be adjusted to accommodate the specific operating conditions encountered by a specific gate.

In operation, the actuator (Shown in FIG. 1) drives the drive pin upwardly or downwardly depending on the desired direction of gate swing. If not obstruction is encountered, rotation of the outer tube 14 relative to the inner tube 16 is transferred through the clutch plates 104, through the support 98 and mounting nut 92 to the outer shell 94. The gate is mounted to the outer shell 94 that is in turn opened as desired.

If the gate mounted to the outer shell 94 encounters an object, it will become decoupled relative to the outer post 14. This decoupling occurs by overcoming the friction forces generated by the downward force provided by the biasing member 102. If the outer shell 94 is prevented from moving due to an obstruction, the actuator will continue to move the outer post 14. However, the torque exerted by the actuator will quickly overcome the frictional forces holding the bearings 106 in place to cause relative rotation of the clutch plates 104. Once the obstruction is removed, the outer shell 94 will begin moving again with the outer post 14.

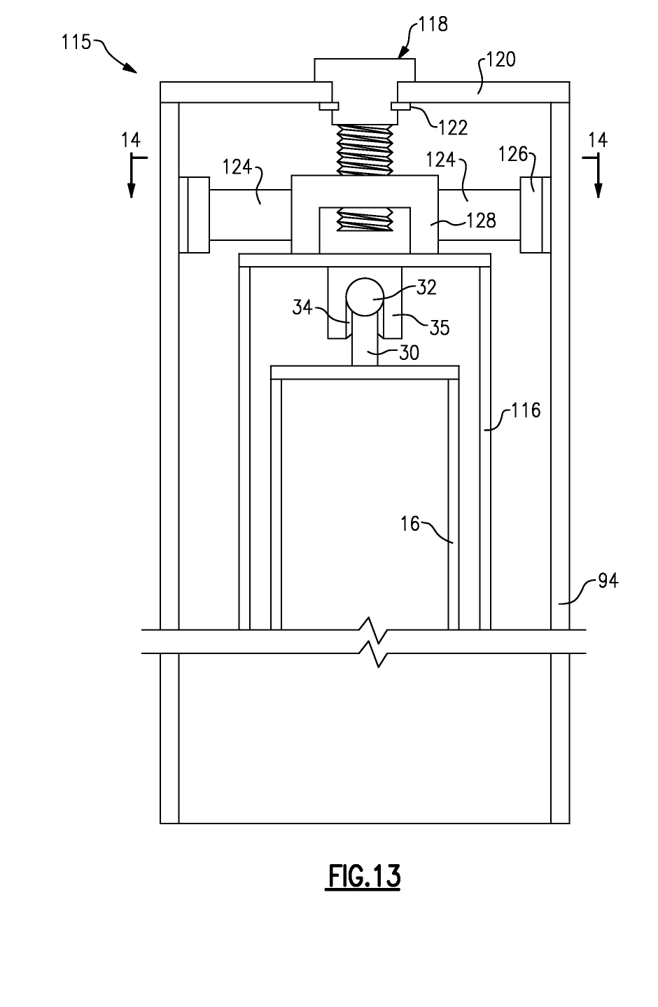

Referring to FIGS. 13 and 14, another clutch assembly 115 includes springs 124 that abut a cam block 128. The springs 124 are biased against a surface 130 of the cam block 124 and are attached to the outer shell 94. The cam block 128 is mounted atop a drive tube 128. The drive tube 128 is rotatable relative to the inner post 16 by a drive mechanism, such as for example the drive mechanism discussed above.

Rotation of the drive tube 116 is translated to rotation of the outer shell through the interface between the cam block 128 and springs 124. The force exerted by the springs 124 against the surface of the cam block 128 can be varied by adjusters 126. The adjusters 126 are accessible through openings in the outer shell 94. The surface 120 of the cam block 128 includes lobes into which the springs 124 fit. An adjustment screw 118 provides for modification of the height of the outer shell 94 relative to the drive tube 116 and the inner tube 16. A clip 122 supports a top cap 120 of the outer shell 94 to facilitated mounting and movement of the outer shell 94 relative to the drive tube 116 and the inner tube 16.

In normal operation, rotation of the drive tube 116 causes rotation of the cam block 128. Rotation of the cam block 128, in turn, causes rotation of the outer shell through the springs 124 interlocked into lobes of the surface 130. The example shape of the cam surface is only one possibility, as other shapes are also within the contemplation of this invention that provides an interlocking abutting surface with the springs 124.

In the event that a gate secured to the outer shell 94 is prevented from moving, for example by an obstruction, the springs 124 will bend inwardly providing movement of the cam block 128 relative to the springs 124 and the outer shell 94. The movement results in forcing the springs 124 to bend outwardly and away from the lobes of the cam block 128. The outward movement of the springs 124 mechanically decouples the drive from the gate to protect the drive mechanism from potential damage.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A powered gate post comprising:
an outer tube supported for rotation relative to an inner tube;
an actuator disposed within the inner tube;
a drive pin moved by the actuator within a slot of the inner tube and drivingly engaged to the outer tube, wherein the slot includes a first portion for rotating the outer tube in a first direction from a closed position and a second portion for rotating the outer tube in a second direction opposite the first direction from the closed position.

2. The powered gate post as recited in claim 1, including a ball bearing disposed along an axis of rotation between the outer tube and the inner tube that supports rotation of the outer tube relative to the inner tube.

3. The powered gate post as recited in claim 2, wherein the ball bearing is disposed between a cup on one of the outer tube and the inner tube and a post disposed on the other of the outer tube and the inner tube.

4. The powered gate post as recited in claim 1, wherein the outer post includes an idler slot within the outer post that receives a portion of the drive pin.

5. The powered gate post as recited in claim 1, wherein the outer post includes an inner channel at the drive pin is drivingly engaged to guide blocks disposed within the inner channel.

6. The powered gate post as recited in claim 1, wherein the outer post includes a D-shaped cross-section.

7. The powered gate post as recited in claim 1, including an outer shell disposed concentric with the outer and inner posts, wherein the outer shell is selectively rotatable through a clutch device.

8. The powered gate post as recited in claim 7, wherein the clutch device comprises a plurality of ball bearings disposed between opposing plates, the opposing plates biased toward each other and movable apart responsive to a force overcoming a biasing force provided by a biasing member.

9. The powered gate post as recited in claim 8, wherein the clutch device includes at least one spring biased against a cam block, wherein the cam block is movable relative to the at least one spring responsive to exceeding a desired load.

10. The powered gate post as recited in claim 1, wherein the actuator drives the drive pin vertically, and the drive slot rotates the drive pin about the axis to facilitate rotation of the outer tube relative to the inner tube.

11. A powered gate assembly comprising:
an inner tube disposed along a central axis;
an outer tube supported for rotation about the central axis by the fixed inner tube; the outer tube including a D-shaped cross-section;
a ball bearing disposed along the central axis and supporting rotation of the outer tube relative to the inner tube;
an actuator disposed within the inner tube;
a drive pin moved by the actuator within a slot of the inner tube and drivingly engaged to the outer tube, wherein the slot includes a first portion for rotating the outer tube in a first direction from a closed position and a second portion for rotating the outer tube in a second direction opposite the first direction from the closed position.

12. The powered gate assembly as recited in claim 11, wherein the outer tube includes channels and the drive pin drives guide blocks movable within the channels for rotating the outer tube relative to the inner tube.

13. The powered gate assembly as recited in claim 12, wherein the channels are defined vertically along an inner surface of the outer tube.

14. The powered gate assembly as recited in claim 11, wherein the ball bearing is disposed between a cup on one of the outer tube and the inner tube and a post disposed on the other of the outer tube and the inner tube.

15. The powered gate assembly as recited in claim 14, wherein the outer post comprises one of at least two vertical posts spaced apart and supported relative to each other by at least one rail.

16. The powered gate assembly as recited in claim 15, wherein the outer post rotates relative to a fixed structure, and an outer surface of the outer post maintains a desired set-off distance between with the fixed structure at any rotational angle.

17. A powered gate assembly comprising:
a drive post mountable to a fixed structure, the drive post including an outer tube supported for rotation relative to an inner tube;
a second post spaced apart from the drive post by at least one connecting rail;
an actuator disposed within the inner tube; and
a drive pin moved by the actuator within a slot of the inner tube and drivingly engaged to the outer tube.

18. The powered gate assembly as recited in claim 17, including two second posts, each spaced apart from the drive post by corresponding at least one connecting rail.

19. The powered gate assembly as recited in claim 17, wherein the powered post includes a D-shaped cross-section for maintaining a desired distance between the fixed structure and an outer surface of the drive post during operation of the powered gate assembly.

20. The powered gate assembly as recited in claim 17, wherein the slot includes a first portion for rotating the outer tube in a first direction from a closed position and a second portion for rotating the outer tube in a second direction opposite the first direction from the closed position.

21. The powered gate assembly as recited in claim 17, including a clutch assembly for selectively decoupling the drive post from the actuator responsive to an obstruction within a swing path of the powered gate assembly.
